(19) United States
(12) Patent Application Publication
(10) Pub. No.: US 2014/0292698 A1
(43) Pub. Date: Oct. 2, 2014

(54) TOUCH DEVICE

(71) Applicants: Interface Optoelectronics (Shenzhen) Co., Ltd., Shenzhen City (CN); GENERAL INTERFACE SOLUTION LIMITED, MIAOLI COUNTY (TW)

(72) Inventor: Chih-Wei Wen, Hsinchu County (TW)

(21) Appl. No.: 14/303,589

(22) Filed: Jun. 12, 2014

(30) Foreign Application Priority Data
Jun. 14, 2013 (CN) 201310234688.5

(51) Int. Cl. G06F 3/041

(52) U.S. Cl. CPC G06F 3/041
USPC 345/173

(57) ABSTRACT

A touch device includes a display module and a first polarizer sheet. The first polarizer sheet is close to a light-emitting side of the display module. The touch device further includes a touch sensing electrode for receiving a gesture command from a user. The touch sensing electrode is directly formed on the first polarizer sheet. The touch sensing electrode is made of metal.

### CROSS REFERENCE TO RELATED APPLICATION

This application claims priority from China Patent Application No. CN 201310234688.5, filed Jun. 14, 2013. The entirety of the above-mentioned patent application is hereby incorporated by reference herein and made a part of this specification.

### BACKGROUND OF THE INVENTION

1. Field of the Invention

The present invention relates generally to a touch device. More specifically, the present invention relates to a touch screen display device.

2. Description of the Prior Art

The popularity of smartphones, tablets, and many types of information appliances is driving the demand and acceptance of common touchscreens for portable and functional electronics. Touch screen displays detect user gestures on the touch screen and translate detected gestures into commands to be performed.

Generally, a touch screen display device is composed of a display module and a touch panel. The display module includes a backlight unit that provides backlight for the device. The touch panel allows a user to send gesture commands to control the device. Typically, the sensing electrode of the touch panel is first formed on a substrate. The electrode-coated substrate is then adhered to the display module.

However, the substrate, on which the sensing electrode is formed, is relatively thick. Therefore, the substrate increases the total thickness as well as the weight of the touch screen display device.

### SUMMARY OF THE INVENTION

It is one object of the invention to provide an improved touch panel so as to reduce weight and total thickness of a touch device encompassing such touch panel.

To these ends, according to one aspect of the invention, A touch device is provided in the present invention. The touch device comprises a display module and a first polarizer sheet. The first polarizer sheet is close to a light-emitting side of the display module. The touch device further comprises a touch sensing electrode for receiving a gesture command from a user. The touch sensing electrode is directly formed on the first polarizer sheet. The touch sensing electrode is made of metal.

Compared to current or conventional art, the present invention touch device utilizes metallic touch sensing electrode that is directly formed on the first polarizer sheet. Therefore, the thickness and weight of the touch device is reduced, thereby achieving a thinner and lighter touch device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the embodiments, and are incorporated in and constitute a part of this specification. The drawings illustrate some of the embodiments and, together with the description, serve to explain their principles. In the drawings:

FIG. 1 is an exploded diagram showing parts of a touch device in accordance with one embodiment of the invention;

FIG. 2 is a perspective view of the touch device in FIG. 1 after assembled;

FIG. 3 is a cross-sectional view of the touch device in FIG. 2 taken along line II-II;

FIG. 4 is a top view showing the layout of touch sensing electrode disposed on a surface of the first polarizer sheet;

FIG. 5 is a cross-sectional view taken along line III-III in FIG. 4; and

FIG. 6 is a cross-sectional view taken along line IV-IV in FIG. 4.

It should be noted that all the figures are diagrammatic. Relative dimensions and proportions of parts of the drawings are exaggerated or reduced in size, for the sake of clarity and convenience. The same reference signs are generally used to refer to corresponding or similar features in modified and different embodiments.

### DETAILED DESCRIPTION

In the following description, numerous specific details are given to provide a thorough understanding of the invention. It will, however, be apparent to one skilled in the art that the invention may be practiced without these specific details. Furthermore, some well-known system configurations and process steps are not disclosed in detail, as these should be well-known to those skilled in the art.

Likewise, the drawings showing embodiments of the apparatus are semi-diagrammatic and not to scale and some dimensions are exaggerated in the figures for clarity of presentation. Also, where multiple embodiments are disclosed and described as having some features in common, like or similar features will usually be described with like reference numerals for ease of illustration and description thereof.

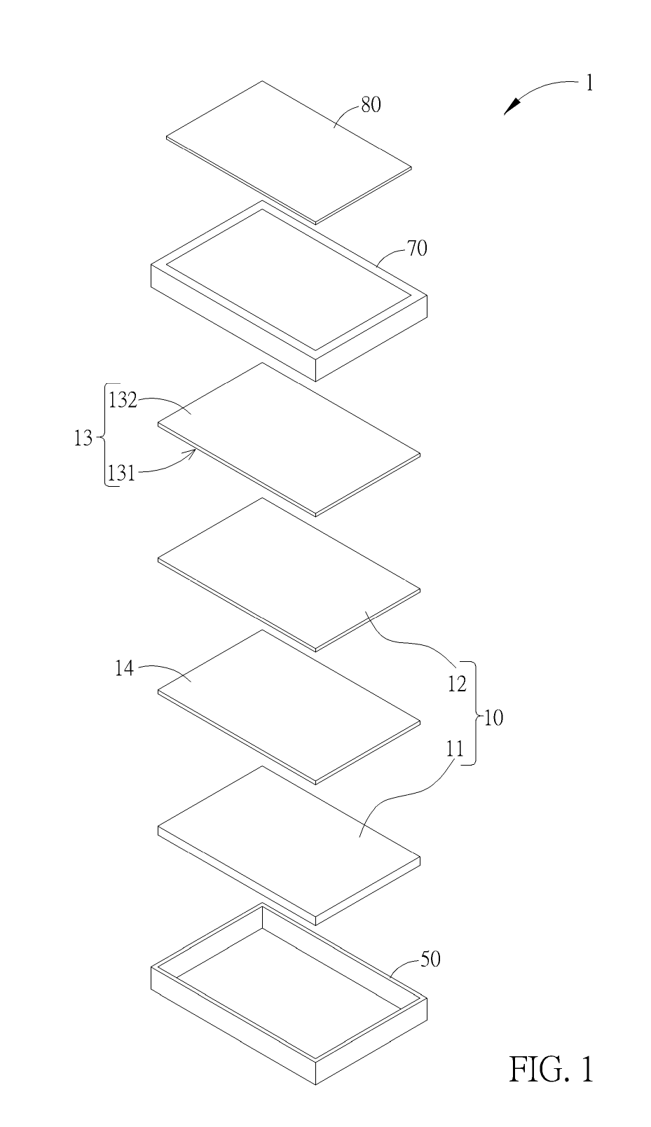

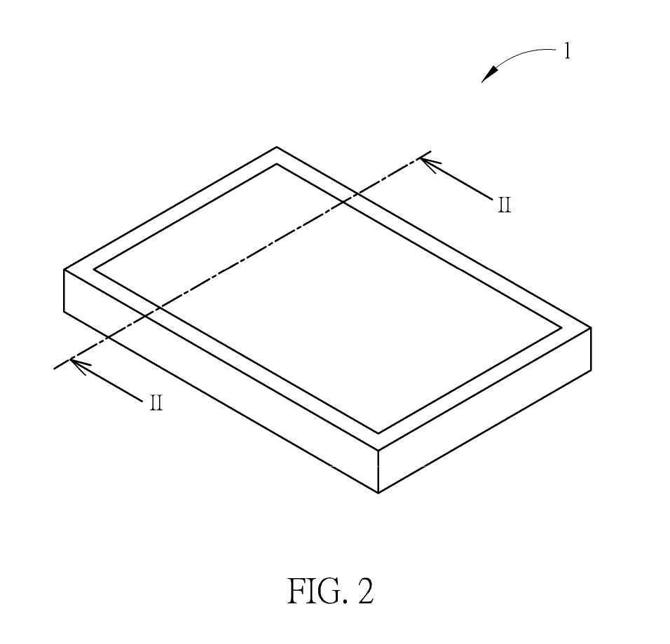

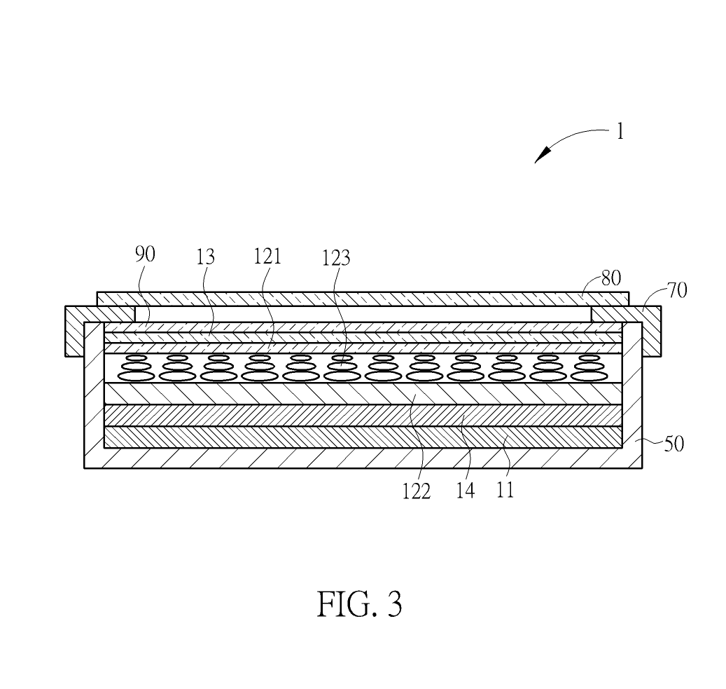

Please refer to FIG. 1 to FIG. 3. FIG. 1 is an exploded diagram showing parts of a touch device in accordance with one embodiment of the invention. FIG. 2 is a perspective view of the touch device in FIG. 1 after assembled. FIG. 3 is a cross-sectional view of the touch device in FIG. 2 taken along line II-II. The touch device 1 comprises a display module 10, a first polarizer sheet 13, a second polarizer sheet 14, a first housing 50, a second housing 70, a protective substrate 80, and a touch sensing electrode 90. The first housing 50 engages with the second housing 70 to form a space for accommodating the display module 10, the first polarizer sheet 13, and the second polarizer sheet 14. The second housing 70 is a hollow frame structure such that the second housing 70 does not hinder the display area of the display module 10.

The display module 10 comprises a backlight unit 11 and a liquid crystal panel 12. The backlight unit 11, the second polarizer sheet 14, the liquid crystal panel 12, and the first polarizer sheet 13 are stacked together in sequence within the first housing 50. That is, the first polarizer sheet 13 is disposed adjacent to the light-emitting side of the display device 10. The backlight unit 11 provides light for the liquid crystal panel 12. The touch sensing electrode 90 is disposed on the first polarizer sheet 13 for receiving a gesture command from a user. The protective substrate 80 corresponds to the touch sensing electrode 90 and is disposed to protect the touch sensing electrode 90.

The liquid crystal panel 12 comprises a first substrate 121, a second substrate 122, and a liquid crystal layer 123 interposed between the first substrate 121 and the second substrate 122. The first substrate 121 is close to the first polarizer sheet 13. The second substrate 122 is close to the second polarizer sheet 14.

The first polarizer sheet 13 comprises a first surface 131 and a second surface 132. The first surface 131 is close to the surface at the light-emitting side of the display module 10. The second surface 132 is opposite to the first surface 131. In this embodiment, the touch sensing electrode 90 is disposed on the second surface 132 of the first polarizer sheet 13.

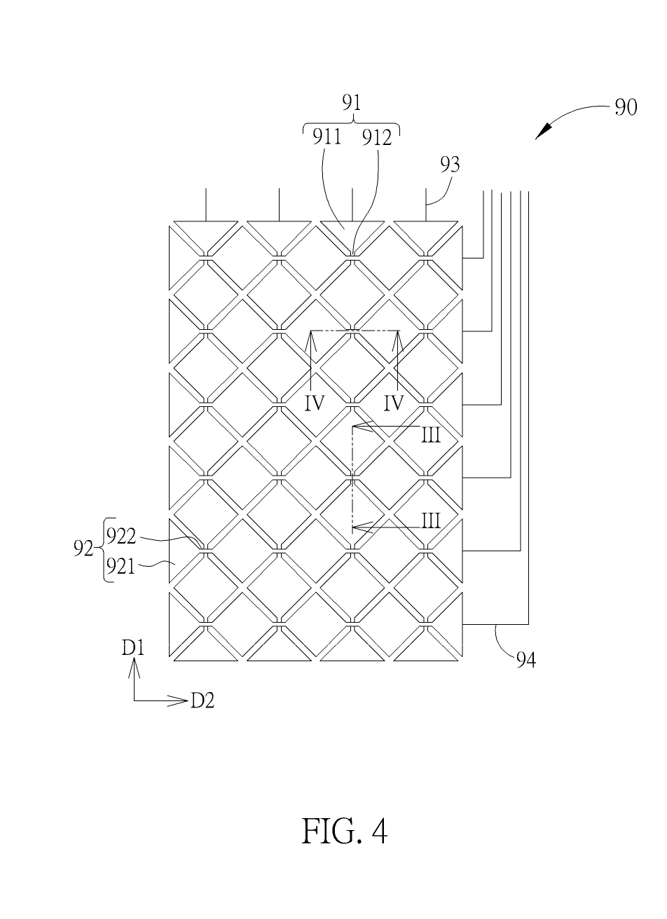

Please also refer to FIG. 4, which shows the structure and layout of the touch sensing electrode 90 disposed on the first polarizer sheet 13. The touch sensing electrode 90 comprises a first sensing wire 91 and a second sensing wire 92. The first sensing wire 91 comprises a plurality of first sensor units 911 and a plurality of first connecting wires 912. The second sensing wire 92 comprises a plurality of second sensor units 921 and a plurality of second connecting wires 922. The plurality of first connecting wires 912 extends along a first direction D1 to serially connect the plurality of first sensor units 911, thereby forming the first sensing wire 91. The plurality of second connecting wires 922 extends along a second direction D2 to serially connect the plurality of second sensor units 921, thereby forming the second sensing wire 92. The first direction D1 is orthogonal to the second direction D2. In this embodiment, the first direction D1 may be a reference Y axis and the second direction D2 may be a reference X axis. The distal end of the first sensing wire 91 and the distal end of the second sensing wire 92 are coupled to a first trace 93 and a second trace 94 respectively, so as to electrically connect with an external driving chip and to receive the driving signals. In this embodiment, the first sensor units 911 and the second sensor units 921 generally have a rhombus shape.

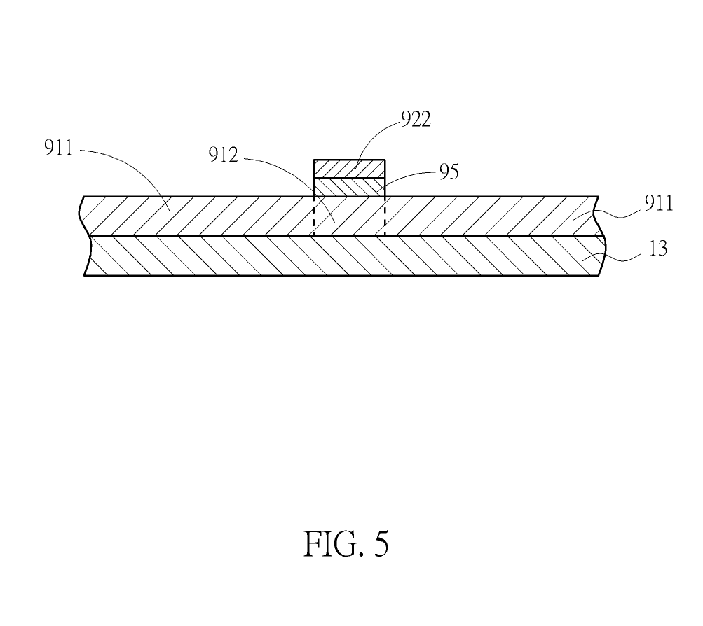

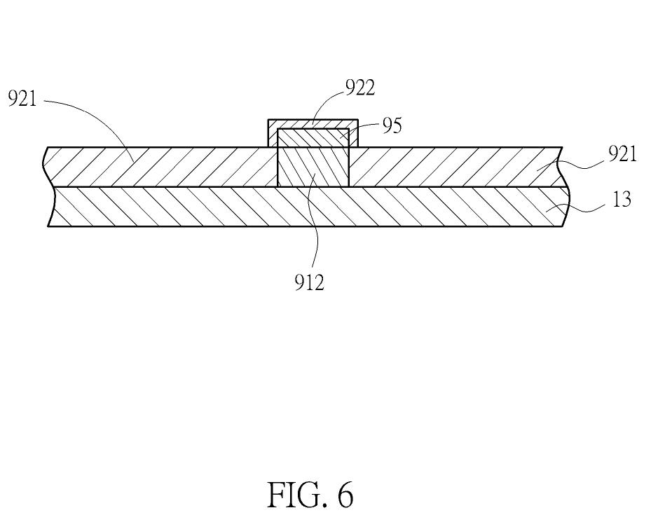

Please refer to FIG. 5 and FIG. 6. FIG. 5 is a cross-sectional view taken along line III-III in FIG. 4. FIG. 6 is a cross-sectional view taken along line IV-IV in FIG. 4. The first sensor units 911 and the second sensor units 921 are disposed on the same horizontal level. Each of the first connecting wires 912 connects adjacent two of the first sensor units 911. In this embodiment, the first connecting wire 912 is coplanar with the first sensor units 911 and the second sensor units 921. The first connecting wire 912 is covered by an insulation layer 95. A second connecting wire 922 is disposed on the insulation layer 95. The insulation layer 95 is used to isolate the first connecting wire 912 from the second connecting wire 922. As can be seen in FIG. 6, each of the second connecting wires 922 connects adjacent two of the second sensor units 921.

The first sensing wires 91 and the second sensing wires 92 are made of conductive materials such as metal, thereby the first sensing wires 91 and the second sensing wires 92 form a metal mesh on the second surface 132 of the first polarizer sheet 13. For example, the aforesaid metal may comprise copper, niobium, chrome, or a composite thereof. The aforesaid metal may comprise silver, palladium, copper, or a composite thereof. Alternatively, the aforesaid metal may comprise molybdenum or aluminum. In order to not let the first sensing wires 91 and the second sensing wires 92 be perceived by a user and to maintain the touch sensitivity, the first sensing wires 91 and the second sensing wires 92 may have a thickness ranging between 1.0˜1.5 micrometers, and a line width ranging between 10˜100 micrometers. Because the first sensing wires 91 and the second sensing wires 92 are made of metal, they provide the advantages of lower resistance and higher sensitivity over the conventional ITO (indium tin oxide) oxide-based sensing wire scheme. Therefore, the present invention structure is suited for large-size or large-scale touch devices.

The first traces 93 and the second traces 94 may be made of a material that is the same as the first sensing wires 91 and the second sensing wires 92. Therefore, the first traces 93 and the second traces 94 may be fabricated concurrently with the first sensing wires 91 and the second sensing wires 92. Compared to the conventional art that utilizes ITO-based sensing wires, the present invention uses metallic traces, thereby simplifying the fabrication process and time.

It is to be understood that, in another embodiment, the touch sensing electrode 90 may be disposed on the first surface 131.

Compared to current or conventional art, the present invention touch device 1 utilizes metallic touch sensing electrode that is directly formed on the first polarizer sheet 13. Therefore, the thickness and weight of the touch device 1 is reduced, thereby achieving a thinner and lighter touch device 1.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch device, the touch device comprising a display module and a first polarizer sheet, wherein the first polarizer sheet is close to a light-emitting side of the display module, characterized in that:
the touch device further comprising a touch sensing electrode for receiving a gesture command from a user, wherein the touch sensing electrode is directly formed on the first polarizer sheet, and wherein the touch sensing electrode is made of metal.

2. The touch device according to claim 1 wherein the first polarizer sheet comprises a first surface and a second surface opposite to the first surface, and wherein the first surface is close to the surface on the light-emitting side of the display module, and wherein the touch sensing electrode is disposed directly on the first surface.

3. The touch device according to claim 1 wherein the first polarizer sheet comprises a first surface and a second surface opposite to the first surface, and wherein the first surface is close to the surface on the light-emitting side of the display module, and wherein the touch sensing electrode is disposed directly on the second surface.

4. The touch device according to claim 1 wherein the touch sensing electrode comprises a plurality of first sensing wires extending along a first direction and a plurality of second sensing wires extending along a second direction, and wherein the touch device further comprises a plurality of first traces and a plurality of second traces, and wherein each of the first sensing wires is electrically coupled to each of the first traces, and each of the second sensing wires is electrically coupled to each of the second traces, and wherein the first traces, the second traces, the first sensing wires, and the second sensing wires are made of the same material.

5. The touch device according to claim 4 wherein each said first sensing wire comprises a plurality of first sensor units and a plurality of first connecting wires serially connecting the first sensor units, and each said second sensing wire comprises a plurality of second sensor units and a plurality of second connecting wires serially connecting the second sensor units.

6. The touch device according to claim 4 wherein said first traces and said second traces further electrically connect with an external driving chip to receive the driving signals.

7. The touch device according to claim 4 wherein the first traces and the second traces are formed concurrently with the first sensing wires and the second sensing wires.

8. The touch device according to claim 1 wherein the first sensing wires and the second sensing wires have a thickness ranging between 1.0˜1.5 micrometers, and a line width ranging between 10˜100 micrometers.

9. The touch device according to claim 1 wherein the touch sensing electrode comprises copper, niobium, chrome, a composite thereof, or silver, palladium, copper, a composite thereof, or molybdenum, or aluminum.

10. The touch device according to claim 1 wherein the touch device further comprises a protective substrate disposed corresponding to the touch sensing electrode.
